(19) United States
(12) Patent Application Publication
(10) Pub. No.: US 2023/0123582 A1
(43) Pub. Date: Apr. 20, 2023

(54) METHOD FOR ACTUATING A TRACK CONDITIONING UNIT OR A WHEEL FLANGE LUBRICATING SYSTEM

(71) Applicant: Siemens Mobility GmbH, München (DE)

(72) Inventors: Alexander Fege, Augsburg (DE); Heiko Meyer, München (DE); Kilian Rossig, München (DE); Stefan Usinger, Dachau (DE)

(21) Appl. No.: 17/910,888

(22) PCT Filed: Mar. 3, 2021
(86) PCT No.: PCT/EP2021/055241

§ 371 Date: Sep. 12, 2022

(30) Foreign Application Priority Data
Mar. 12, 2020 (DE) 10 2020 203 188.6

(51) Int. Cl. B61C 15/10; B61K 3/02; B61F 5/12; B61K 9/08

(52) U.S. Cl. CPC B61C 15/107; B61K 3/02; B61F 5/127; B61K 9/08

(57) ABSTRACT

A method for actuating a track conditioning unit or a wheel flange lubricating system of a rail vehicle. The track conditioning unit provides auxiliary agent to sub-regions of a rail on which the rail vehicle is travelling, in order to increase friction between the wheel and the rail. A wheel flange lubricating system provides a fluid to a wheel sub-region of the rail vehicle or to a rail sub-region, in order to reduce friction between the wheel and the rail. A relative movement between a railcar body and a bogie of the rail vehicle is detected using path measurement, in order to detect a bend in the track. Based on the path measurement, the track conditioning unit or the wheel flange lubricating system is actuated in a targeted manner according to the bend, such that the auxiliary agent or fluid is applied in a resource-saving yet effective manner.

The invention relates to a method for actuating a track conditioning unit or a wheel flange lubricating system of a rail vehicle.

In order to improve the tractive power or the braking power of a rail vehicle, it is known to take measures on the rails. For this purpose, a track conditioning unit is used, as is known, for example, from the document WO 2019 219223 A1. The track conditioning unit is used to apply auxiliary agents (sand, air) with high accuracy to the rails over which travel takes place, in order to increase friction between the wheel and rail and therefore the tractive and braking power of the rail vehicle as necessary.

In addition, in the event of a wear-promoting, unfavorable wheel set or individual wheel position relative to the rail, it is known to use a wheel flange lubricating system of a rail vehicle in order to reduce the material wear and noise emission induced by the position by applying a fluid (e.g. a lubricant or oil). The fluid is applied to a wheel sub-region, for example to a wheel running surface, or to a rail sub-region in the vicinity of the wheel.

In order to be able to use the track conditioning unit or in order to be able to use the wheel flange lubricating system in an optimized way, it is necessary to adapt them to the actual rail course during operation by means of an actuation. This makes it possible for an auxiliary agent or fluid to be applied to the rail or wheel in a targeted and resource-saving manner.

The object of the present invention is to specify a method for actuating a track conditioning unit or a wheel flange lubricating system with which, during the use of a track conditioning unit or a wheel flange lubricating system, targeted and resource-saving application of auxiliary agents or of fluid to wheel or rail is made possible.

This object is achieved by the features of claim 1. Advantageous developments are specified in the dependent claims.

The invention relates to a method for actuating a track conditioning unit or a wheel flange lubricating system of a rail vehicle.

As part of the rail vehicle, the track conditioning unit applies an auxiliary agent as necessary to sub-regions of a rail on which the rail vehicle is traveling, in order to increase friction between the wheel and rail.

As part of the rail vehicle, the wheel flange lubricating system brings applied a fluid as necessary to a wheel sub-region (for example to a wheel running surface) or to a rail sub-region in the vicinity of the wheel. The fluid is preferably applied in the vicinity of the wheel flange. Friction between wheel and rail is reduced by the fluid.

A relative movement between the railcar body and the bogie of the rail vehicle is detected continuously with the aid of a displacement measurement in order to detect a bend in the track.

On the basis of the displacement measurement, the track conditioning unit or the wheel flange lubricating system is actuated in a targeted manner depending on the bend, so that the auxiliary agent (in particular air or sand) is applied in a resource-saving and efficient manner.

The auxiliary agent is preferably applied to a rail sub-region, while the fluid is applied to a wheel sub-region.

The fluid is applied to a wheel sub-region, for example to a wheel running surface or in the vicinity of a wheel flange. If appropriate, the fluid can also be applied to a rail sub-region close to the rail, in order to lubricate the rail sub-region over which travel takes place before contact with the wheel.

The present invention is based on the fact that when a rail vehicle travels through bends, there is a relative movement between the railcar body and the bogie. This relative movement is detected and evaluated in order to detect the bend in the track, to assess it and then to actuate the track conditioning unit or the wheel flange lubricating system in a targeted manner, depending on the bend.

Therefore, the auxiliary agent or fluid is metered or used in a targeted manner, depending on the bend.

In the present invention, the relative movement between the railcar body and bogie is determined by a displacement measurement with the aid of sensors.

The displacement measurement via the sensors is carried out, for example, in accordance with optical, inductive, ultrasound-based or capacitive measurement principles, which are designed and arranged in such a way that the relative movement between the railcar body and bogie can be determined via the displacement measurement.

In a preferred development, the relative movement is determined by a displacement measurement on dampers. The dampers are provided between the railcar body and bogie for predetermined spatial directions and are fitted in order to damp the relative movement.

In a preferred development, the dampers include the sensors which determine the damper displacements. On the basis of the damper displacements, as explained above, bends in the track are detected and evaluated, in order then to actuate the track conditioning unit or a wheel flange lubricating system in a targeted manner, depending on the bend.

By means of the method according to the invention, a system for displacement measurement, which preferably monitors six degrees of freedom between the railcar body and bogie, is used to actuate the track conditioning unit or the wheel flange lubricating system depending on the detected track bend, so that auxiliary agents or fluid are applied to the rail in a targeted and resource-saving manner.

By means of the method according to the invention, an optimal action of the track conditioning unit is ensured, irrespective of the alignment and traveling conditions.

By means of the method according to the invention, auxiliary media are saved and equipment for producing and storing auxiliary media (air, compressed air, sand) can be dimensioned to be smaller, and thus costs can be saved.

By means of the method according to the invention, an optimal action of a wheel flange lubricating system is ensured, irrespective of the alignment and of traveling conditions.

By means of the method according to the invention, (lubricating) fluid is saved while maintaining complete functionality.

By means of the method according to the invention, the environment is protected.

By means of the method according to the invention, depending on the bend the track conditioning unit is actuated correctly in accordance with a transverse offset and the type of the bend.

By means of the method according to the invention, the wheel flange lubricating system is operated in a bend-sensitive manner. In the event of a bend detection or relatively small bend radii, the wheel flange lubrication is actuated in a targeted manner and with a defined metering rate or with defined metering pulses for the fluid.

The present invention will be explained in more detail below by way of example and with reference to a drawing.

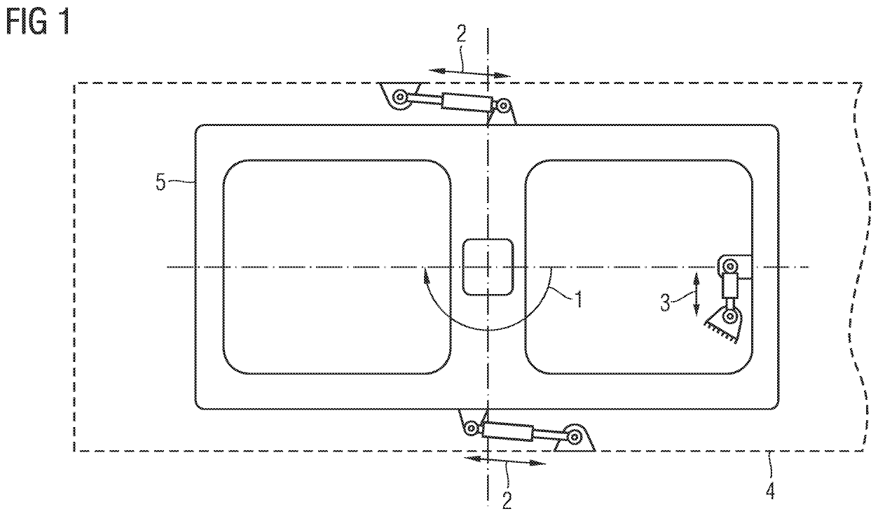

FIG. 1 shows the method according to the invention, in which, with the aid of a displacement measurement, a wheel position of a rail vehicle in the transverse direction relative to the rail is detected in an indirect way.

Use is made of the effect that a bogie 5 carrying the wheel rotates in a direction 1 relative to the railcar body 4 when traveling through a curve.

This rotation is determined via a displacement measurement. For example, displacement measuring sensors WMS are provided, which are coupled to a roll damper 2 or to a transverse damper 3.

In a preferred development, the displacement measurement sensors WMS are an integral constituent part of the roll damper 2 or the transverse damper 3.

The damper displacements determined by measurement are used to detect a transverse offset between wheel and rail or to detect bends in the track.

From the displacement measurement, it is possible in particular to derive information
relating to the type of bend (i.e. is this a right-hand bend or a left-hand bend),
relating to the bend radius, and
relating to a transverse offset between the wheel and rail.

It is therefore possible to actuate the track conditioning unit correctly in accordance with a transverse offset and the type of track bend.

In addition, it is possible to operate the wheel flange lubricating system in a bend-sensitive manner, i.e. in the event of a bend detection or relatively small bend radii, to actuate the wheel flange lubrication in a targeted manner and with a defined metering rate.

1-4. (canceled)

5. A method for actuating a track conditioning unit or a wheel flange lubricating system of a rail vehicle, the method comprising:
selectively applying, with a track conditioning unit being a part of the rail vehicle, an auxiliary agent as necessary to a sub-region of a rail on which the rail vehicle is traveling, in order to increase friction between a wheel and the rail;
selectively applying, with a wheel flange lubricating system being a part of the rail vehicle, a fluid as necessary to a wheel sub-region of the rail vehicle or to a rail sub-region, in order to reduce friction between the wheel and the rail;
continuously detecting a relative movement between a railcar body and a bogie of the rail vehicle in order to detect a bend in the track, by detecting the relative movement by a displacement measurement on dampers that are disposed between the railcar body and the bogie for predetermined spatial directions in order to damp the relative movement between the railcar body and the bogie; and
based on the displacement measurement, selectively actuating the track conditioning unit or the wheel flange lubricating system in a targeted manner depending on the bend in the track, to apply the auxiliary agent or the fluid in a resource-saving manner.

6. The method according to claim 5, which comprises using sensors for carrying out the displacement measurement.

7. The method according to claim 6, wherein the sensors carry out the displacement measurement based on a principle selected from the group consisting of an optical, inductive, ultrasound-based, and capacitive measurement principle.
